(19) United States
(12) Patent Application Publication
(10) Pub. No.: US 2015/0026578 A1
(43) Pub. Date: Jan. 22, 2015

(54) METHOD AND SYSTEM FOR INTEGRATING USER GENERATED MEDIA ITEMS WITH EXTERNALLY GENERATED MEDIA ITEMS

(71) Applicant: Sightera Technologies Ltd., Nes-Ziona (IL)

(72) Inventors: Alexander RAV-ACHA, Rehovot (IL); Oren BOIMAN, Givat Brener (IL)

(21) Appl. No.: 14/337,382

(22) Filed: Jul. 22, 2014

Related U.S. Application Data
(60) Provisional application No. 61/856,775, filed on Jul. 22, 2013.

(51) Int. Cl. G06F 3/0484; G06F 17/30

(52) U.S. Cl. CPC G06F 3/04842; G06F 17/30781
USPC 715/723

(57) ABSTRACT

A method for integrating user generated media items with externally generated media items may include: obtaining one or more user-generated media items captured by a user during one or more events; obtaining a plurality of externally generated media items, wherein at least one of the media items was captured independently of the one or more events; analyzing the user-generated media items, to extract visual data of the user-generated media items; automatically selecting a subset of the externally generated media items, based on a visual relationship between visual data of the selected externally generated media items and the visual data of the user-generated media items; and automatically producing a media sequence comprising portions of the user-generated media items and portions of the selected externally generated media items.

### CROSS-REFERENCE TO RELATED APPLICATIONS

This application claims priority from U.S. Provisional Patent Application No. 61/856,775, filed on Jul. 22, 2013, which is incorporated herein by reference in its entirety.

### TECHNICAL FIELD

The present invention relates generally to video editing, and more particularly, to employing computer vision techniques in assisting with video editing.

### BACKGROUND OF THE INVENTION

Prior to the background of the invention being set forth, it may be helpful to set forth definitions of certain terms that will be used hereinafter.

The term “object” as used herein is defined as an entity in a photo, or set of photos, that corresponds to a real object in the world, e.g. a person, pet or even a general thing such as a car. Therefore, a single person that is recognized in multiple photos will be considered as a single object, having several instances.

The term “event” as used herein is defined as a physical situation or occurrence, located at a specific point in space and time.

The term “media items” as used herein is defined as photos, videos, and multimedia files, as well as portions thereof.

The term “user generated” as used herein is defined as content that was captured by a human user via a capturing device such as a camera or a mobile phone.

The term “external” as used herein is defined as content that has been generated independently of content that has been generated during events and that was not generated or selected by the same user. Content is external only given specified events.

Video channels such as YouTube™ channels are becoming a popular tool for promoting brands such as music bands or commercial brands. However, even for well-known brands, these videos are usually not gaining a large number of views. The reason is that without personal content, most of these videos do not become viral so that most viewers do not have enough motivation for sharing them with their family or friends.

It would be therefore advantageous to provide a manner by which personalized content can be effectively combined with content which is external to the personalized content (e.g., branded content) and so to increase the popularity of the combined content.

### SUMMARY OF THE INVENTION

Some embodiments of the present invention provide an automatic method for combing personal and external content in an edited video. Such external content can be, for example, a footage that relates to a brand as long as it was captured and produced independently of the events during which the personal content was captured.

Advantageously, and from the brand standpoint, such edited videos may serve as a personalized viral advertisement of the brand, which injects the brand-essence to the specific personal experience.

Advantageously, and from the user's standpoint, the same videos are considered by the users as a capture of their own personal life experience, being upgraded with extra premium content. Therefore, they may have a higher motivation to share these videos with their family and friends.

In order for the combined videos to be made to look natural and appealing, and not as if a commercial content was added to the video (as is the case for post-rolls or tailored templates), it is important to deeply understand the content using automatic video and photo analysis, and to mix the content in a way that serves the story telling of the user experiences.

Some embodiments of the present invention provide a method for integrating user generated media items with externally generated media items. The method may include: obtaining one or more user-generated media items captured by a user during one or more events; obtaining a plurality of externally generated media items, wherein at least one of the media items was captured independently of the one or more events; analyzing the user-generated media items, to extract visual data of the user-generated media items; automatically selecting a subset of the externally generated media items, based on a visual relationship between visual data of the selected externally generated media items and the visual data of the user-generated media items; and automatically producing a media sequence comprising portions of the user-generated media items and portions of the selected externally generated media items.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic block diagram illustrating a system according to embodiments of the present invention;

FIG. 2 is a schematic block diagram illustrating a template according to embodiments of the present invention;

FIG. 3 is a block diagram illustrating an aspect of the system in accordance with embodiments according to the present invention;

FIG. 4 is a block diagram illustrating another aspect of the system in accordance with embodiments according to the present invention;

FIG. 5 is a high level flowchart illustrating a method in accordance with embodiments according to the present invention; and

FIG. 6 is a high level flowchart illustrating another method in accordance with embodiments according to the present invention.

### DETAILED DESCRIPTION OF THE INVENTION

With specific reference now to the drawings in detail, it is stressed that the particulars shown are by way of example and for purposes of illustrative discussion of the preferred embodiments of the present technique only, and are presented in the cause of providing what is believed to be the most useful and readily understood description of the principles and conceptual aspects of the present technique. In this regard, no attempt is made to show structural details of the present technique in more detail than is necessary for a fundamental understanding of the present technique, the description taken with the drawings making apparent to those skilled in the art how the several forms of the invention may be embodied in practice.

Before at least one embodiment of the present technique is explained in detail, it is to be understood that the invention is not limited in its application to the details of construction and the arrangement of the components set forth in the following description or illustrated in the drawings. The present technique is applicable to other embodiments or of being practiced or carried out in various ways. Also, it is to be understood that the phraseology and terminology employed herein is for the purpose of description and should not be regarded as limiting.

Some embodiments of the present invention provide an automatic video editing method for combining a personal footage generate by a user (e.g., videos and photos) with an external content. The video editing may be based on known methods such as those disclosed in US Patent Application Publication No. 2011/0218997, which is incorporated herein by reference in its entirety.

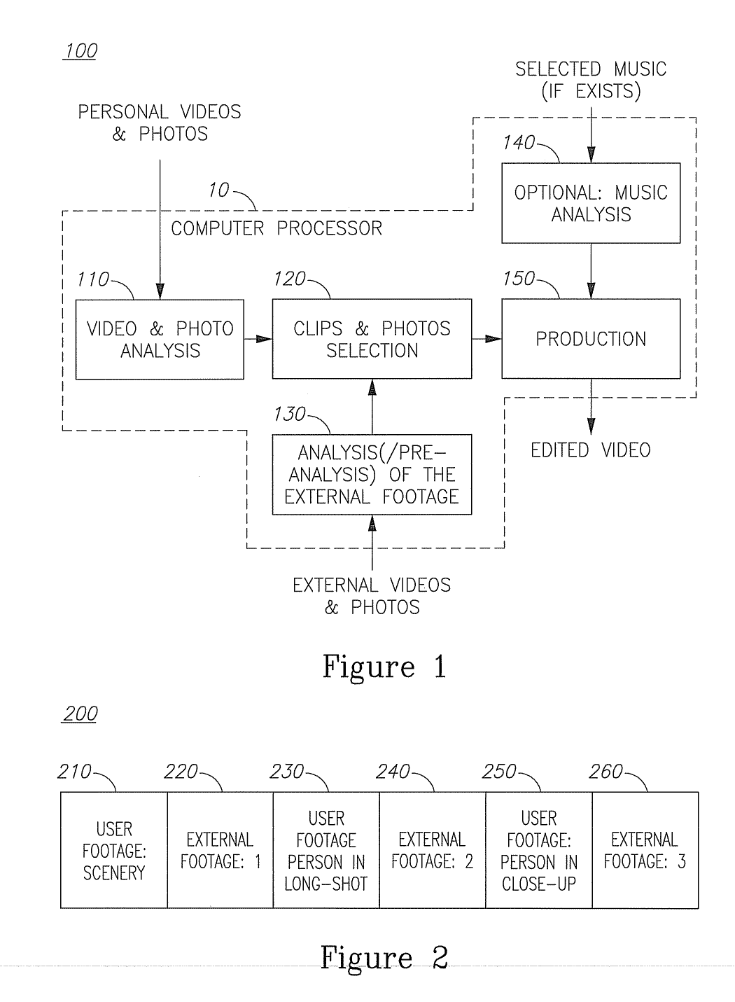

FIG. 1 is a schematic block diagram illustrating a system 100 according to embodiments of the present invention. The system may be implemented by a computer processor 10 on which a plurality of software modules are being executed. The user may select his or her own personal footage (videos and photos) which is being inputted into analysis module 110. Additional external material is also selected (either by the user, or automatically by the system) and is being inputted into analysis module 130 (which may or may not be separated from analysis module 110). Both the personal and the external materials are analyzed (the personal footage is analyzed automatically, and the external one might be analyzed manually in advance), to yield meta-data.

The meta-data extracted from the analysis modules 110 and 130 may be used as an input to a clip and photo selection module 120 based on the quality or relevancy of different parts in the footage, and also based on video editing considerations some of which are well known in the art.

The selected clips are being inputted into production module 150 in which the selected clips and photos are combined with effects and transitions, and synchronized with the attached soundtrack (if exists), to produce the edited video. Optionally, music selected by a user (if exists) may be inputted to yet another analysis module 140 to further affect production module 150 in generating the edited video.

Production module 150 may further add effects and transitions, and synchronizes the transitions to the soundtrack. Optionally, the production block can use different sets of visual effects and transitions, one for the personal content and one of the external one. In one specific implementation, the effects will be applied only on the personal footage, and the external footage will have no effects and only simple transitions (such as simple cuts). The idea behind such an implementation is that usually the external footage has higher quality, and is better picked (sometimes it is even already edited in advance), and therefore it requires fewer effects.

The clip selection block may also use different parameter sets for the personal and for the external content, such as using different editing tempos. For example, the clip selection algorithm may choose shorter clips for the external material (high tempo) and longer clips for the personal one (e.g., choose a few seconds of someone talking).

In order for the combining of external and user generated content to be made to look natural, and for it to be edited it in a way that will upgrade the edited video (instead of downgrading it), it is recommended to take into account the following issues:
Selecting an external content that is relevant to the user content. Some examples for such relevancy can be:
   Both user and external content relate to the same topic or context (e.g., videos taken during a sport event that are mixed with videos and photos of the team, or videos that are taken in Disneyland that are mixed with premium content of the park).
   Location-based relevancy (e.g., mixing external footage that was taken from the same place as the user's footage).
   Relevancy by music: The soundtrack or audio of the video corresponds to the external content. For example, mixing videos of users, in which they are singing or dancing, with the content obtained from the artist of that specific song.
The mixing should be based on optimizing some video editing criteria, such as optimizing the story-telling. To do so, it is important to take into account the visual content of the user's footage and the external footage using automatic video and photo analysis, for example, using the algorithm described in US Patent Application Publication No. 2011/0218997 (The external footage can be manually or automatically analyzed in advance). For example, a known criteria for good video editing is known as ‘continuous editing’, which tries to avoid visible cuts. One way to do it is by trying to keep a relation of reasoning between consecutive shots, for example, if someone is looking to the left, the next shot may show the scene whose location is on the left side of this person. Another example is having a mutual scene or object between consecutive shots (which make the cuts feel “invisible”). Additional examples of avoiding visual cuts is avoiding cuts in the beggining of an action, or avoiding cuts in the middle of a speech.

In a specific implementation, the combining (or the mixing) may be based on general video editing rules. By way of a non-limiting illustration, such rules are disclosed in US Patent Application Publication No. 2011/0218997 which is incorporated herein in its entirety, where the external and personal footage are used together as input footage for the automatic video-editing algorithms. In this case, there is no distinction (in the editing algorithm) between the personal and the external content. Even in this case, it is still important to keep the right balance between the two sources of footage (e.g., not to use only the external or only the personal footage).

The selection and mixture of the external and personal content can be further improved by pre-analyzing the external content in advance (This can be done manually).

It should be noted that, unlike many popular methods for “planting” advertises inside a video or photo, in the above examples we are talking about adding a significant footage to the video which will be part of the story telling—according to one embodiment of the proposed method, periods of the edited video are generated solely from the external content, and the mixing of the external content requires that the content of the external material will be relevant for the story-telling.

As described before, the selection of the external footage that will be used in the video editing and the editing itself are based on video editing criteria, using the visual analysis of the footage. Also should be noted that there are many video editing algorithms existing in the literature, for example the algorithms described in US Patent Application Publication No. 2011/0218997. Examples for video editing criteria, whose optimization yield “good” edited videos, are described next.

Some examples for video editing criteria that can be used for the selection and editing are:
Avoid jump-cuts: cuts from two consecutive video shots of the same scene. A way to avoid such jump cuts is simply by trying to avoid multiple selections of shots or photos from the same scene.
Cut on similar elements—try to keep a common visual element between consecutive shots (See next sections on content matching or objects detection, which demonstrate this rule).
Using B-roll—an additional footage that gives more details about the shot currently being played. B-roll can be used, for example, to avoid cutting a speech from the previous selection, by applying only a visual cut while continuing playing the audio corresponding to the previous selection.
Mixing of External & User's footage based on content matching

Given a specific brand, there is a question of what parts of the footage to use for a specific user. This footage might be selected manually by the user, but in other implementations, there is a bank of external footage, from which only parts are selected automatically.

One method to do this is by matching the user footage with the external material to find footage with a similar visual content (e.g., finding in the external content a photo or video that belongs to the same scene as one of the user's footage). This matching may be done using pattern matching or using descriptor based methods known in the art. It may also be based on external meta-data, such as GPS.

Given a match, the respective user footage might be replaced with a similar external material in the edited video. For example, a long-shot photo of the Disney park can be replaced with a similar (but of higher quality) external photo.

Alternatively, this scene matching can be used not to replace the user content, but rather to be used in selecting the most relevant external content. For example, if we detect a user picture with Mickey Mouse, we can decide to add more external footage of Mickey Mouse. This match may also influence the placement of the external material in the edited video, for example by placing nearby in the edited video the user and external footage that belong to the same scene.

The examples described in the previous paragraphs describe a matching between the same scenes or objects, but a more general match can also be used, for example, matching visual attributes of the content, such as matching daylight content to the external daylight content, user indoor content to external indoor content, and the like.

Selection and Mixing of External & Personal footage based on objects

There are various known ways to extract objects from photos and videos. Described herein are several such methods that can be used for this task.

There are various classes of objects, whose detection is broadly discussed in the literature. For example, detection of faces is a well-known problem in computer vision, and there exist a large number of methods that addresses this problem, such as the method discussed at Paul Viola and Michael Jones, Robust Real-time Object Detection, IJCV 2001, which is incorporated herein by reference in its entirety. Other examples are person detection as in Navneet Dalal, Bill Triggs and Cordelia Schmid, Human detection using oriented histograms of flow and appearance, ECCV 2006, pp. 428-441, which is incorporated herein by reference in its entirety.

A detection scheme for general pre-defined object classes is presented in “TextonBoost, Joint Appearance, Shape and Context Modeling for Multi-Class Object Recognition and Segmentation”, Jamie Shotton, John Winn, Carsten Rother and Antonio Criminisi, in European Conference on Computer Vision (2006), pp. 1-15, which is incorporated herein by reference in its entirety.

Optionally, an object can be manually indicated by the user, e.g., by tapping on the camera's screen, where an instance of this object appears.

When the analyzed footage is a video or a sequence of images, there is more information that can also be used for object detection. For example, one of the most popular methods is detection of moving objects based on background subtraction. A survey of various methods for motion-based extraction of objects and their tracking is shown in “A Survey on Moving Object Detection and Tracking in Video Surveillance System”, Kinjal A Joshi, Darshak G. Thakore, International Journal of Soft Computing and Engineering (IJSCE), pages 2231-2307, Volume 2, Issue 3, July 2012, which is incorporated herein by reference in its entirety.

In order for information regarding an object from multiple frames to be extracted, it is important to be able to track an object over time. As long as the object appears in the field of view of the camera, or even if it disappears for a short time, there are many traditional object tracking algorithms that are able to identify its existence and calculate its position over multiple frames.

In other cases, for example, if the object appears in two images that are taken at totally different times, under different capturing conditions (e.g., video vs. photo) or under different lighting conditions, object recognition can be used to identify that two images contain the same object. This can be done using various object recognition and indexing techniques, for example, using the method described in W. Zhao, R. Chellappa, A. Rosenfeld and P. J. Phillips, Face Recognition: A Literature Survey, ACM Computing Surveys, 2003, pp. 399-458, which is incorporated herein by reference in its entirety for the case of faces (“Face Recognition”), or using the method described for general objects in US Patent Application Publication No. 2011/0218997, which is incorporated herein by reference in its entirety.

In one embodiment of the patent, the selection placement in the edited video, is based on object matching. Objects are detected in both the user and the external content (the detection and recognition of the objects in the external footage can be done in advance, and may be done manually).

Photos and videos that include mutual objects in both the user's and external footage, are getting higher preference to be selected (for both the external and for the user's footage). In addition, pairs of photos or videos having the same object are getting higher preference to be placed consecutively in the edited video. This preference aims to improve the story-telling continuity of the edited video, which is a well-known rule in traditional video editing.

A simple example for the object-based matching is the following: Assume that the user is shooting footage in a sports event, and a player A is shown in one of the photos. A photo of the same player may be chosen from the respective external library, and this photo can be displayed consecutively to the original photo in the resulting edited video.

Object detection can be used for in a more general manner for selecting and placing the external footage in the edited video. We describe several selection criteria that are based on object detection and/or recognition:
Add a preference for selecting external footage that may include of pre-defined objects (such as faces or people).
Add different preferences based on the topic of the users footage. For example—prefer external content with similar classes of objects to the user's footage (e.g.—people, pets or cars).

Use object-based preferences based on the target location in the edited video. For example, when selecting the best shot of the edited movie, which will be used as an “establish” of the movie, one can use different preferences than the selection of other parts of the movie (e.g., selecting a scenery video for the first shot, versus selecting photos with people for the next shots).

FIG. 2 is a schematic block diagram illustrating a further aspect according to embodiments of the present invention. In one embodiment of the invention, the selection and mutual editing of the external footage and the user footage can be done based on pre-defined templates. Editing the external and user footage may be carried out based on pre-defined templates such as template 200. The templates can include requirements 210-260 each requirement relating to the visual content of the selections, e.g., having a specific class of object, or other visual data.

Different templates can be attached with different selections of external libraries or sub-sets of footage, and the selection of the relevant template can also be based on its fitness to the visual content of the user's footage, such as including a specific class of objects (“person”, “dog”), a specific recognized object (“Dan”, “Micky-Mouse”) or other visual attributes (“Day light”, “Long-shot”, “Scenery”, and the like).

A possible important step in creating edited videos is adding music and visual effects and transitions. This step is used to create an edited music clip. In this step, the selected footage is usually synchronized to the music. In addition, visual effects and transitions between consecutive selections are also added.

In one embodiment of the present invention, the visual effects and transitions can depend also on the visual content of the external footage. For example: A slow motion effect may be applied on top of an external video clip that shows some action. Additional example is a ‘zoom-in’ transition which may be chosen to be applied between consecutive (external) clips having a similar object but from different ranges (e.g., close up vs. long shot). Another example is a zoom in effect applied on top of an external footage, e.g., a photo, if this footage includes a face of an important person.

Since the external footage may be analyzed in advance, these effects and transition may be determined in advance. However, in other cases, these effects and transitions may be determined given the selected user's footage, as they may depend on this selection (e.g.—a special transition between clips of a similar scene, which will be applied only if the user and external clip will belong to the same scene).

Varying editing parameters and style based on the origin of the content

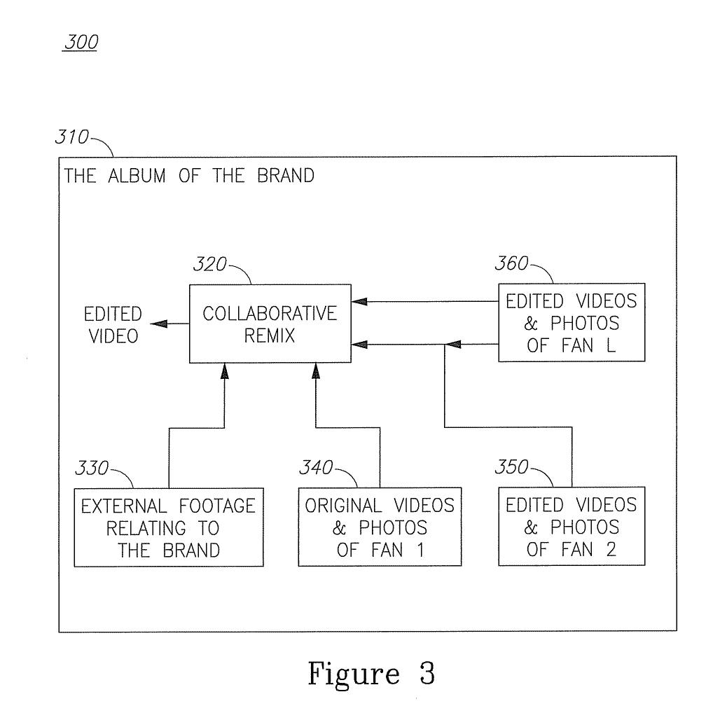

FIG. 3 is a block diagram illustrating an aspect of the system in accordance with embodiments according to the present invention. In some embodiments, the mixture of external content can be done using a “Collaborative Remix” in which two or more users are capturing the media items during the same event and the combined edited video is based on media items from all users as well as the externally generated content.

In a case that one or several users have generated edited videos, then these edited videos, optionally also with some additional raw material, can be combined with an external material in a post-processing (i.e., a remix).

In one case example, the input user footage can all be videos that relates to a single topic—for example, all are videos generated by fans of the specific brand. In this case, the meta-data computed for the first editing stage for each video can be saved and reused for editing the remix.

Collaborative remix 320 is achieved by taking video & photos (either edited or the non-edited) of multiple users/fans 320, 350 and 360 in the album 310, and editing them together with external footage 330 into a single edited video

One of the key challenges in mixing personal and external content is determine the proper balance between the external vs. the personal content. There are several rules or methods that can be used for this purpose:
Set a constant ratio between the amounts of external versus personal footage. For example, having the same duration of user and external content in the edited video.
Letting this ratio depend on the amount of the user's footage. For example, if the total duration of videos and/or number of photos selected by the user is small, we would increase the amount of external footage that is being selected for the editing. The idea behind this rule is that the external content can help to upgrade dull user content with additional high-value content.

This ratio might depend on the content of the user's footage, in various ways:
Determining the actual “richness” of the footage based on parameters such as : Number of scenes, detected faces, existence of speech, amount of motion/action, existence of other objects, number of characters, image quality, etc’. These parameters can be calculated using automatic video & photo analysis (See prior patent [1]). For example, if the content is defined as boring (e.g., consisting of a single static scene), it will result in increasing the percentage of the external footage in the resulting edited video.
The personal footage itself can be clustered to “highly personal” and “less personal” content. The “highly personal” material may be identified by having: shots of important characters, moments of speech, close-ups, and the like. The “less personal” material may be identified by videos and photos having scenery shots, long-shots, panoramas, background objects, and the like. The algorithm may prefer to replace “less personal” content with an external one, and keep the “highly personal” content, as the personal content is more essential for the personalization of the edited video.

In a specific implantation, the user footage can be matched with the external footage to find similar content (e.g., a scenery photo of the same scene) and be replaced with this specific external footage. For example, a long-shot photo of the Disney Park can be replaced with a similar external photo (but of higher quality).

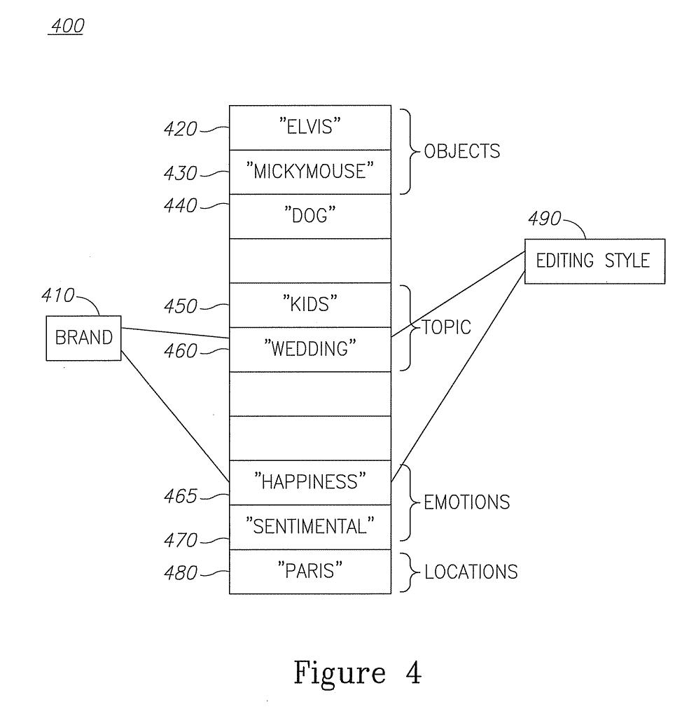

FIG. 4 is a block diagram illustrating another aspect of the system in accordance with embodiments according to the present invention. Mapping diagram 400 provides a possible implementation showing how the relationship between a brand 410, being an externally generated content and an editing style 490 may be formed. Various themes or content attributes 420-480 grouped into sub groups such as objects, topics, emotions, and location, constitutes a plurality of routes between brand 490 and editing style 490. In one example, a specific brand 410 is required to be associated with a theme of “happiness” 465 and also with the theme of “wedding” 460. The combination of these two themes is associated in turn with a specific editing style 490. Thus, a relationship is formed between a specific brand and a specific editing style based on the requirements associated with the brand. It is understood that other routes can connect brands (or other externally generated content) with editing styles. Sometimes, more than one editing style is related to a single brand and vice versa.

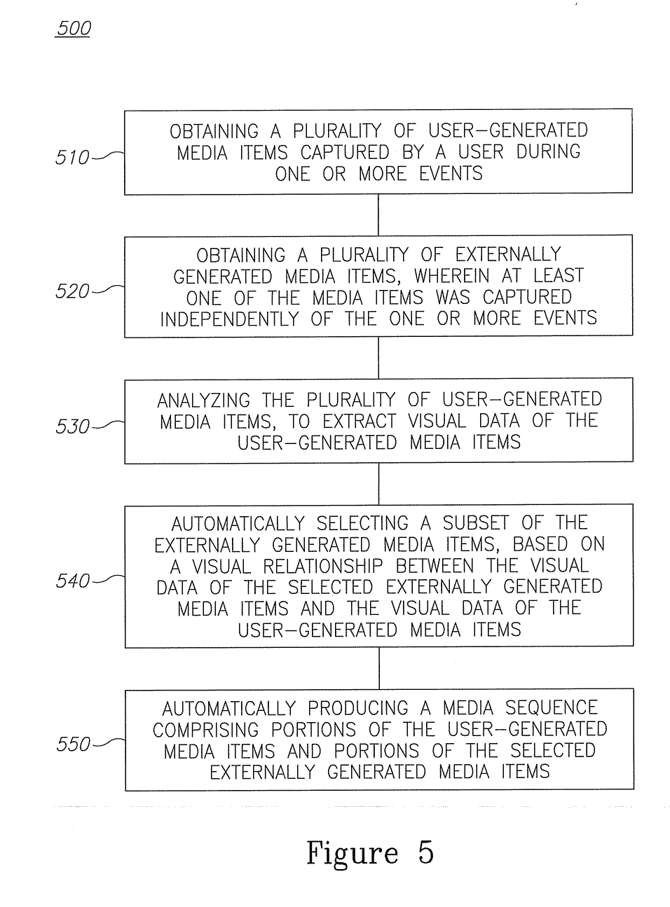

FIG. 5 is a high level flowchart illustrating a method in accordance with embodiments according to the present invention. Flowchart 500 summarizes a generalized method discussed above by the following steps: obtaining a plurality of user-generated media items captured by a user during one or more events 510; obtaining a plurality of externally generated media items, wherein at least one of the media items was captured independently of the one or more events 520; analyzing the plurality of user-generated media items, to extract visual data of the user-generated media items 530; automatically selecting a subset of the externally generated media items, based on a visual relationship between the visual data of the selected externally generated media items and the visual data of the user-generated media items 540; and automatically producing a media sequence comprising portions of the user-generated media items and portions of the selected externally generated media items 550.

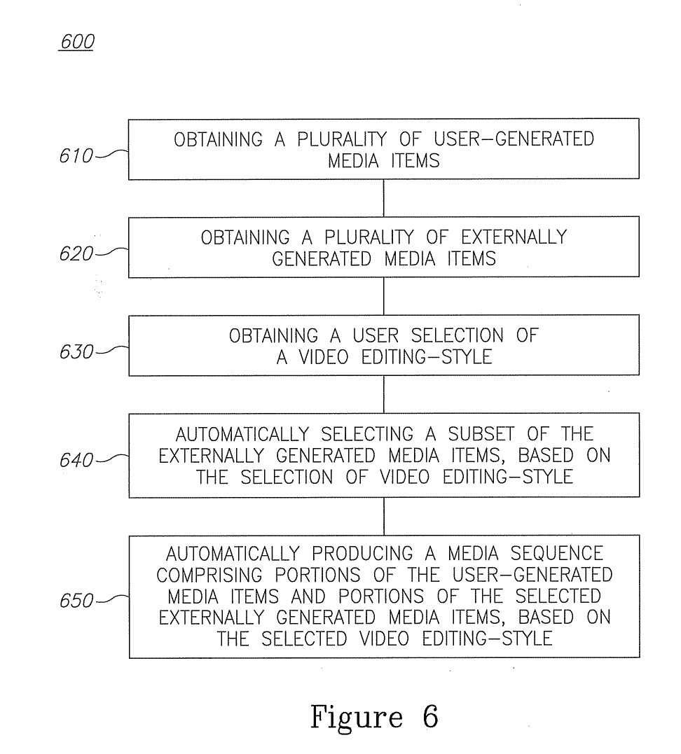

FIG. 6 is a high level flowchart illustrating another method in accordance with some embodiments according to the present invention. Flowchart 600 summarizes a the aforementioned editing style related method discussed above by the following steps: obtaining a plurality of user-generated media items 610; obtaining a plurality of externally generated media items 620; obtaining a user selection of a video editing-style 630; automatically selecting a subset of the externally generated media items, based on the selection of video editing-style 640; and automatically producing a media sequence comprising portions of the user-generated media items and portions of the selected externally generated media items, based on the selected video editing-style 650.

According to some embodiments of the present invention several methods for matching external and user's content may be used. In some implementations there might be multiple external libraries (e.g., corresponding to multiple brands), each having a different set of footage. When the user wishes to edit his video, he can select an external library (or the respective brand), or the system can automatically select one or a subset of external libraries that are the most relevant for that user or for that specific session.

This selection of relevant external libraries can be based on any of the following:
Location (E.g., using GPS)—selecting external libraries that relates to the location where the footage was captured.
Event (E.g., users participating in a sport event, will be suggested to use footage of their team).
Content analysis (Find external libraries having similar attributes to the user's footage, or external libraries with footage that includes mutually recognized objects with the user's content).
Word search (if the user inserts text or key words).
List of themes or topics—the user can choose a topic or a theme for the editing, and this can be used to filter the relevant external libraries.
Social networks—for example, using the information that a user likes specific external libraries, according to his history of actions such as his ‘likes’ or ‘follows’ in Facebook or other Social networks. This information can also be derived indirectly according to actions of the user's friends (assuming that he likes similar external libraries as his or her friends).
History of usage—the user may be suggested with a braded content based to his or her own history of usage (e.g., external libraries that were selected by the user in the past).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Some methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
obtaining one or more user-generated media items captured by a user during one or more events;
obtaining a plurality of externally generated media items, wherein at least one of the media items was captured independently of the one or more events;
analyzing the user-generated media items, to extract visual data of the user-generated media items;
automatically selecting a subset of the externally generated media items, based on a visual relationship between visual data of the selected externally generated media items and the visual data of the user-generated media items; and
automatically producing a media sequence comprising portions of the user-generated media items and portions of the selected externally generated media items.

2. The method according to claim 1, wherein the externally generated media items are generated automatically by automatic visual analysis.

3. The method according to claim 1, wherein the selecting of the subset of the externally generated media items, is further based on predefined video editing criteria.

4. The method according to claim 3, wherein at least one of the video editing criteria is continuity of the produced media sequence.

5. The method according to claim 1, wherein the visual relationship corresponds to a similarity in a topic of the externally generated media items and the user generated media items.

6. The method according to claim 3, wherein a placement of the media portions in the produced media sequence is determined based on the video editing criteria.

7. The method according to claim 1, wherein a placement of media portions in the produced media sequence is determined based on an analysis of an added soundtrack to the sequence.

8. The method according to claim 1, wherein a placement of media portions in the produced media sequence is determined based on an automatic analysis of an added soundtrack to the sequence.

9. The method according to claim 1, wherein the visual relationship is determined based on appearance of specific objects in both user-generated media items and externally generated media items.

10. The method according to claim 1, further comprising indexing the plurality of externally generated media items with at least one of: context, location, and topic, and wherein the selecting of the subset of externally generated media items is carried out based on the indexing.

11. The method according to claim 6, wherein the automatically selecting and placement are carried out simultaneously by feeding the user-generated media items and the externally generated media items to a decision function.

12. The method according to claim 11, wherein the decision function takes into account visual similarities between the media items.

13. The method according to claim 1, wherein the portions of the selected externally generated media items include at least one time segment of a video footage.

14. The method according to claim 1, wherein the producing further includes adding a soundtrack to the media sequence based on relevance to the selected media items.

15. The method according to claim 1, wherein the producing further includes generating transitions between a plurality of media items in the sequence, wherein the transitions are determined based on visual data associated with the selected externally generated media items.

16. The method according to claim 1, wherein the produced media sequence is not synchronized in time with the one or more user-generated media items.

17. The method according to claim 1, wherein the one or more user-generated media items are captured by two or more users during the at least one event.

18. The method according to claim 1, wherein at least some of the user-generated media is already edited.

19. A method comprising:
obtaining one or more user-generated media items;
obtaining a plurality of externally generated media items;
obtaining a user selection of a video editing-style;
automatically selecting a subset of the externally generated media items, based on the user selection of video editing-style; and
automatically producing a media sequence comprising portions of the one or more user-generated media item and portions of the selected externally generated media items, wherein the producing is carried out using the selected video editing-style.

20. The method according to claim 19, further comprising attaching at least one video editing-style with a first list of content attributes; and
further comprising attaching at least one subset of the externally generated media items with a second list of content attributes; and
wherein the selecting a subset of the externally generated media items is done by matching the first and second lists of content attributes.

21. The method according to claim 20, wherein at least one of the content attributes corresponds to at least one of: topic, object, emotion, and location.

22. A system comprising:
A computer processor configured to obtain one or more user-generated media items captured by a user during one or more events and obtain a plurality of externally generated media items, wherein at least one of the media items was captured independently of the one or more events;
an analyzing module configured to analyze the one or more user-generated media items, to extract visual data of the user-generated media items;
a selection module configured to automatically select a subset of the externally generated media items, based on a visual relationship between the visual data of the selected externally generated media items and the visual data of the user-generated media items; and
a production module configured to automatically produce a media sequence comprising portions of the user-generated media items and portions of the selected externally generated media items,
wherein the modules are executed by said computer processor.

23. A system comprising:
a computer processor configured to obtain: one or more user-generated media items, a plurality of externally generated media items, and a user selection of a video editing-style;
a selection module configured to automatically select a subset of the externally generated media items, based on the selection of video editing-style; and
a production module configured to automatically produce a media sequence comprising portions of the one or more user-generated media item and portions of the selected externally generated media items, carried out using the selected video editing-style,
wherein the modules are executed by said computer processor.
